(19) United States
(12) Patent Application Publication
(10) Pub. No.: US 2025/0382524 A1
(43) Pub. Date: Dec. 18, 2025

(54) METHOD, APPARATUS AND SYSTEM FOR PRODUCING HYDROGEN AND NON-GASEOUS PRODUCTS FOR INDUSTRIAL APPLICATIONS, ENERGY PRODUCTION, AND ASSOCIATED ELECTRIC POWER GENERATION

(71) Applicant: VISA AUST PTY LTD, Fitzroy, Victoria (AU)

(72) Inventors: Bruno Salvatore ANGELICO, Deepdene, Victoria (AU); Bradley John ATTARD, Greensborough, Victoria (AU); Keith Michael HENLEY-SMITH, Keilor Lodge, Victoria (AU); David Robert WILSON, Clifton Hill, Victoria (AU); Walter Mario BILIC, Fitzroy, Victoria (AU)

(21) Appl. No.: 18/834,741

(22) PCT Filed: Jan. 31, 2023
(86) PCT No.: PCT/AU2023/050060

§ 371 Date: Jul. 31, 2024

(30) Foreign Application Priority Data
Jan. 31, 2022 (AU) 2022900174
May 23, 2022 (AU) 2022901378
May 24, 2022 (AU) 2022901396

(51) Int. Cl. C10B 57/06; B01J 6/00; B01J 23/745; B03C 1/18; C01B 3/02; C01B 3/50; C10B 53/02; C10B 53/07; C10B 53/08; C10J 3/20; C10J 3/72; H02K 7/18

(52) U.S. Cl. CPC C10B 57/06; B01J 6/00; B01J 23/745; B03C 1/18; C01B 3/02; C01B 3/501; C01B 3/506; C10B 53/02; C10B 53/07; C10B 53/08; C10J 3/20; C10J 3/723; H02K 7/1823; B03C 2201/20; C10J 2200/06; C10J 2300/0906; C10J 2300/0909; C10J 2300/092; C10J 2300/0923; C10J 2300/093; C10J 2300/0946; C10J 2300/0986; C10J 2300/1603; C10J 2300/1625; C10J 2300/1675

(57) ABSTRACT

The present invention relates to the processing of carbonaceous materials for, inter alia, hydrogen production. In particular, the invention relates to the production of hydrogen, for example, as input for industrial manufacturing applications or as a fuel source for the associated generation of electric power. In one form, the invention provides a method of producing hydrogen comprising the step of reacting a combination of solid carbonaceous material and a catalyst comprising alpha phase iron-based material adapted to produce an exothermic reaction with the solid carbonaceous material.

### RELATED APPLICATIONS

This application claims the priority of Australian Provisional Patent Application No. 2022900174 in the name of BXB Technologies Pty Ltd, which was filed on 31 Jan. 2022, entitled “Method, Apparatus and System for Producing Hydrogen and Non-Gaseous Products for Industrial Applications, Energy Production, and Associated Electric Power Generation”, Australian Provisional Patent Application No. 2022901378 in the name of Henley-Smith et al., which was filed on 23 May 2022, entitled “PAK450 Metallic Material”, and Australian Provisional Patent Application No. 2022901396 in the name of Henley-Smith et al., which was filed on 24 May 2022, entitled “Reduction of Metallic Ores”, and the specifications thereof are incorporated herein by reference in their entirety and for all purposes.

### FIELD OF INVENTION

The present invention relates to the processing of carbonaceous materials for, inter alia, hydrogen production. In particular, the invention relates to the production of hydrogen, for example, as input for industrial manufacturing applications or as a fuel source for the associated generation of electric power. It will be convenient to hereinafter describe the invention in relation to a thermal reaction between carbonaceous material and an alpha phase iron catalyst comprising one or a combination of a ferrimagnetic oxide of iron and alpha ferrite, from which non-gaseous products and a number of gases are released, one of which is hydrogen for use as fuel gas. However, it should be appreciated that the present invention is not limited to that use, only.

### BACKGROUND ART

Throughout this specification, the use of the word “inventor” in singular form may be taken as a reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

There are numerous methods known for the production of hydrogen as a fuel and energy resource. For example, ‘Green’ hydrogen production methodologies involve electrolysis to produce hydrogen, which utilises an electric current to split water into hydrogen and oxygen. If the input electricity is produced by renewable sources, such as solar or wind, the resulting hydrogen will be considered renewable as well. It has been stated that the Green hydrogen market could generate revenues, at the very least, of $US12 trillion by 2050—bigger than any industry we have now.”¹ ‘Grey/Brown’ hydrogen production comprises coal reforming/gasification in a process that converts brown coal into carbon monoxide (CO), hydrogen (H₂) and carbon dioxide (CO₂). Typically, this is achieved by pyrolysis in which the material reacts at between about 900° C. and about 1,150° C. As stated at Petrofac², Grey hydrogen production is essentially the same as ‘Blue’ hydrogen production except the CO₂ by-product is released into the atmosphere. ‘Blue’ hydrogen production typically involves natural gas reforming in which hydrogen is produced by reacting natural gas with high-temperature steam. This method is considered the cheapest, most efficient, and most common. Natural gas reforming accounts for no less than about 70% of the hydrogen currently produced. Furthermore, according to Petrofac², ‘Pink’ hydrogen production is similar to green hydrogen, as it is made via electrolysis, but uses nuclear energy as the source of power and, a further type of hydrogen made by electrolysis is ‘Yellow’ hydrogen, where electrolysis is achieved solely through solar power, unlike green which could use a combination of renewable energy sources such as wind or solar. ¹Andrew Forrest, Fortescue Metals Group, on the ABC (Australian Broadcasting Corporation) Boyer Lectures in January 2021²https://www.petrofac.com/media/stories-and-opinion/the-difference-between-green-hydrogen-and-blue-hydrogen/

Hydrogen is considered to be environmentally friendly, in particular, because its combustion by the end consumer does not produce any CO₂ emissions. However, it is to be noted that greenhouse gas emissions may be produced in the course of the production and supply of hydrogen.

Hydrogen manufacture using current technology involves high capital expenditure (CAPEX), high operational expenditure (OPEX), high levels of CO₂ emissions, high temperatures (in the order of about >900° C.-1,000° C.) and high-power requirements per kg of hydrogen generated.

Examples showing deficiencies with current technologies utilised for renewable and alternate energy production are as follows:
Solar & Coal/Gas, which has high CAPEX & high OPEX.
Coal & Gas steam reforming of hydrogen, which generates large CO₂ emissions.
Huge energy input is needed per kg of hydrogen produced.
Minimal or no useful or commercial by-products.
Large footprint & infrastructure is required for wind-solar farms.
Solar energy runs for only about 20-30% of the time and wind power generation is also limited with its operational time. Depending on the location, energy derived from solar panels and wind-powered generation are limited and are otherwise open to the elements with regard to operational times. As such, solar panels only derive power when the sun is shining and turbines operate when the wind blows.
New power distribution infrastructure is needed.
Carbon Capture & Sequestration (CCS) increases costs per kilogram & use of energy.
Electrolysis systems require use of high volumes of specially treated water, which is an inefficient use of a valuable resource.

Throughout the 1960s, '70s and '80s, which coincided with activity in both the polymer industry and historic oil/energy crises, research and development had been undertaken in the hydrogenation of coal. This activity was primarily directed at the improved production of alkanes of various types. However, some research was also carried out for the reverse process of dehydrogenation³ of coal products where hydrogen is released. An example of this activity is found in the paper publication of Yokono et al⁴. This publication is directed at an evaluation of catalysts for use in the liquefaction of coal, i.e., converting coal into liquid hydrocarbons, namely, liquid fuels and petrochemicals, and in doing so Yokono et al. performed a number of hydrogen-evolving pyrolysis reactions at temperatures of about 450° C. on coal samples with a range of different Fe₂O₃-Metal-Oxide catalysts in respective proportions of 10:1 by weight to produce yields of approximately 1 tonne of coal per kg of Hydrogen. ³See Chapter 12: Dehydrogenation of Alkanes (2005)⁴Tetsuro YOKONO, Shoichi IYAMA, Yuzo SANADA, Tsutomo YAMAGUCHI and, Tokio IIZUKA, “Dehydrogenation of Coal over Catalysts: Evaluation of Catalysts for Liquefaction” (1982) Journal of Japan Petroleum Institute, Vol. 27, No. 6 1984.

Entering the 21^{st} century, interest in the production of hydrogen for fuel has increased markedly. Huffman⁵ is a presentation that discusses Hz production from C1, i.e., single carbon atom-molecules, namely, methane (CH₄), carbon monoxide (CO), carbon dioxide (CO₂), and methanol (CH₃OH). This presentation indicates that research has been conducted using catalysts consisting of iron oxide/metal complexes in the form of Fe-M, where M=Ni, Mo, or Pd, on gaseous alkanes that have shown excellent activity and lifetimes for non-oxidative dehydrogenation of the noted gaseous alkanes, yielding pure hydrogen in one step with no CO or CO₂ produced. However, the processes disclosed by Huffman fall well short of addressing an efficient method of producing H₂ from solid carbonaceous materials. ⁵Gerald P. Huffman, University of Kentucky, Consortium for Fossil Fuel Sciences (CFFS), “Production and Storage of Hydrogen Using C1 Chemistry” (Apr. 19, 2006).

An example of numerous hydrogen-producing processes that have been developed is disclosed in U.S. Pat. No. 7,588,676 (Reichman et al.). Reichman et al. is directed at the production of hydrogen from carbonaceous matter via an electrochemical reaction in the presence of a base catalyst in which carbonate and/or bicarbonate ions are produced as a by-product.

Conversion of natural gas into hydrogen is contemplated by Hazer Group⁶. However, the process disclosed by Hazer Group relates to the production of hydrogen from gaseous hydrocarbons using iron ore as a catalyst at high temperatures and does not address the need for producing H₂ from solid carbonaceous materials such as coal or waste organic materials and plastics etc. ⁶https://hazergroup.com.au/about/#hazerprocess

Further examples of industrial processes that may form related prior art are as follows.

US patent application publication No. 2011/0024687 (White et al.) is of general interest in the area of catalysis. White et al. discloses processes which comprise alternately contacting an oxygen-carrying catalyst with a reducing substance, or a lower partial pressure of an oxidizing gas, and then with the oxidizing gas or a higher partial pressure of the oxidizing gas, whereby the catalyst is alternately reduced and then regenerated to an oxygenated state. In certain embodiments disclosed by White et al., when processing feedstock in a reduction stage, carbon dioxide and hydrogen are created as product gases. However, White et al. requires a reaction involving an oxidised catalyst and furthermore, requires a pressurised environment.

US patent application publication No. US20140163120 (Kyle) is directed to a method of converting carbon containing compounds such as coal, methane or other hydrocarbons into a liquid hydrocarbon fuel. The process disclosed by Kyle utilizes a high pressure, high temperature reactor which operates upon a blend of a carbon compound including CO₂ and a carbon source, a catalyst, and steam. Microwave power is directed into the reactor. The catalyst, preferably magnetite, will act as a heating media for the microwave power and the temperature of the reactor will rise to a level to efficiently convert the carbon and steam into hydrogen and carbon monoxide.

US patent application publication No. 2018/0195006 (Dayton et al.) is directed to a process for converting biomass into a hydrocarbon fuel using pyrolysis. Dayton et al. discloses processes for converting a biomass starting material (such as lignocellulosic materials) into a low oxygen containing, stable liquid intermediate that can be refined to make liquid hydrocarbon fuels. More specifically, the process can be a catalytic biomass pyrolysis process wherein an oxygen removing catalyst is employed in the reactor while the biomass is subjected to pyrolysis conditions. The stream exiting the pyrolysis reactor comprises bio-oil having a low oxygen content, and such stream may be subjected to further steps, such as separation and/or condensation to isolate the bio-oil.

European patent application No. EP3138892 (Synthopetrol et al.) is directed to production of a liquid biofuel and discloses the use of a heterogeneous solid catalyst comprising or consisting of a metal complex linked by covalent bonds and/or by Van der Waals type interactions on a magnetic carrier for the implementation of a hydrotreatment reaction of gas derived from the pyrolysis of a substrate, the said hydrotreatment reaction being carried out with hydrogen and with said gas in the presence of said catalyst and leading to a gaseous phase, said gaseous phase leading by a step of cooling to the production of a liquid phase formed of liquid biofuel.

U.S. Pat. No. 10,106,407 (Siriwardane et al.) is directed to producing synthesis gas from methane via oxidation. Embodiments disclosed in Siriwardane et al. include delivering a metal ferrite oxygen carrier to a fuel reactor, wherein the metal ferrite oxygen carrier comprises MFeₓO_{y} where 1≤x≤3 and 3≤y≤5, and where M comprise a Group II alkali earth metals; and delivering a gaseous stream that contains methane to the metal ferrite oxygen carrier in the fuel reactor and maintaining the fuel reactor at a reducing temperature sufficient to reduce some portion of the metal ferrite oxygen carrier and oxidize some portion of the methane containing gas stream. Embodiments further include generating gaseous products containing Hz and CO gas in the fuel reactor; withdrawing a product stream from the fuel reactor, where the gaseous products comprise the product stream, and where at least >50 vol. % of the product stream includes CO and H₂; oxidizing the reduced carrier in an oxidizing reactor by contacting the reduced carrier and an oxidizing gas at an oxidizing temperature, where the oxidizing gas is comprised of oxygen, and where the oxidizing temperature is sufficient to generate an oxidizing reaction, where the reactants of the oxidizing reaction comprise some portion of the oxygen, some portion of the M component, and some portion of the Fe_{c}O_{d} component, and further wherein the product of the oxidizing reaction is a re-oxidized carrier that comprises some portion of the MFeₓO_{y}; and delivering heat generated in the oxidizing reactor to the fuel reactor for the reaction of metal ferrite with methane.

CN101891149A (ENN Science and Technology Development Co Ltd) relates to a continuous method for preparing combustible gas from a high concentration slurry of a carbon-containing organic matter. The method can be continuously carried out by decompressing and continuously discharging a reaction product. The decompressing and continuous discharging operation is implemented by adopting at least two buffer tanks operated in parallel or at least one pressure-reducing valve. The disclosure of CN101891149A also relates to equipment for preparing the combustible gas from the high concentration slurry of the carbon-containing organic matter.

A method for producing hydrogen and nano-carbon by catalytic decomposition of methane (CDM) is disclosed in Qian et. al. “Methane decomposition to produce COₓ-free hydrogen and nano-carbon over metal catalysts: A review” International Journal of Hydrogen Energy, 2020. Vol. 45, Pages 7981-8001. However, it is noted the CDM for COx-free hydrogen production is still in its infancy. The urgency for industrial scale of CDM is more important than ever in the current situation of huge COx emission. This review studies CDM development on Ni-based, noble metal, carbon and Fe-based catalysts, especially over cheap Fe-based catalyst to indicate that CDM would be a promising feasible method for large hydrogen production at a moderate cheap price. Besides, the recent advances in the reaction mechanism and kinetic study over metal catalysts are outlined to indicate that the catalyst deactivation rate would become more quickly with increasing temperature than the CDM rate does. This review also evaluates the roles played by various parameters on CDM catalysts performance, such as metal loading effect, influences of supports, hydrogen reduction, methane reduction and methane/hydrogen carburization. Catalysts deactivation by carbon deposition is the prime challenge found in CDM process, as an interesting approach, a molten-metal reactor to continually remove the floated surface solid carbons is put forwarded in accordance to overcome the deactivation drawback. Moreover, particular CDM reactors using substituted heating sources such as plasma and solar are detailed illustrated in this review in addition to the common electrical heating reactors of fixed bed, fluidized bed reactors. The development of high efficiency catalysts and the optimization of reactors are necessary premises for the industrial-scale production of CDM.

A discussion of ferrites as catalysts for steam reforming of ethanol is disclosed in Stolyarchuk et al. “FERRITES MFe2O4 (M=Mg, Mn, Fe, Zn) AS CATALYSTS FOR STEAM REFORMING OF ETHANOL.” Theoretical and Experimental Chemistry, 2016, Vol. 52, No. 4, pages 246-251. As discussed by Stolyarchuk et al., steam reforming of ethanol (SRE) over complex magnesium, manganese, iron, and zinc oxides at 823 K was investigated. It was shown by X-ray phase analysis that the catalytically active phase consists of the ferrites of the respective metals with spinel structure. The yield of hydrogen over manganese and magnesium ferrites is greater than 80% with the absence of CO in the reaction products.

The production of pure hydrogen from methane mediated by the redox of Ni- and Cr-added iron oxides is discussed in Takenaka et al. “Production of pure hydrogen from methane mediated by the redox of Ni- and Cr-added iron oxides.” Journal of Catalysis. 2004, Vol. 228, pages 405-416. In this study, the preferable effects of the addition of Ni and Cr species into iron oxides on the redox reactions is reported. The iron oxides containing both Ni and Cr species could produce pure hydrogen repeatedly with high reproducibility through the reduction with methane and the subsequent oxidation with water vapor at lower temperatures, compared to the iron oxides with both Cu and Cr species. In addition, the role of Ni and Cr species added to the iron oxide samples on the redox reactions was examined on the basis of the local structures of these additives.

U.S. Pat. No. 8,920,525 (Despen et al.) discloses processes and systems for converting biomass into high-carbon biogenic reagents in the form of pyrolyzed solids.

The preceding discussion of the background art is intended to facilitate an understanding of the present invention only. The discussion is not an acknowledgement or admission that any of the material referred to is or was part of the common general knowledge as at the priority date of the application.

### SUMMARY OF INVENTION

An object of the present invention is to alleviate at least one disadvantage associated with the related art.

In general, the present invention provides a method of producing hydrogen comprising the step of:
reacting a combination of solid carbonaceous material and a catalyst comprising alpha phase iron-based material adapted to produce an exothermic reaction with the solid carbonaceous material.

The method may comprise the steps of:
combining a mixture of the solid carbonaceous material and the catalyst;
reacting the mixture by heating said mixture to a temperature of at least about 100° C.

In preferred embodiments of the invention, the catalyst comprises alpha ferrite.

The catalyst may comprise one or a combination of:
a ferrimagnetic oxide of iron;
a ferrite;
magnetite.

Preferably, the magnetite comprises Fe₃O₄ and the ferrite comprises FeO.

The mixture of the solid carbonaceous material and the catalyst may comprise:
about 90% by weight solid carbonaceous material and;
about 10% by weight catalyst.

The step of reacting the mixture may include heating said mixture to a temperature of up to about 1,000° C.

The method may further comprise the step of:
reacting the mixture of the solid carbonaceous material and the catalyst to produce a supply of alpha ferrite for further catalysing the reaction.

The step of reacting may be performed within a furnace in a reaction chamber or a retort.

The method may further comprise the step of:
operating the furnace to a temperature of no more than about 1,000° C. to sustain an exothermic reaction of the mixture of solid carbonaceous material and the catalyst.

The method may further comprise the step of:
drying the mixture before the step of reacting said mixture to produce an anhydrous combination comprising the carbonaceous material and the catalyst.

The step of drying may be carried out at about 35° C.

The method may further comprise one or more of the steps of:
extruding the mixture before the step of drying to form the mixture into pellets
moulding the mixture before the step of drying to form the mixture into moulded shapes for optimizing heat transfer.

The solid carbonaceous material may comprise one or a combination of:
a coal;
sugar and/or sugar-cane;
corn;
plastic;
rubber;
waste pit sludge; and,
waste materials.

The plastic noted above may comprise one or a combination of:
polyvinyl chloride (PVC);
poly ethylene terephthalate (PET);
low density polyethylene (LDPE), and;
high density polyethylene (HDPE).

The coal noted above may comprise one or a combination of:
Peat;
Lignite; and,
Sub-bituminous coal.

The waste materials noted above may comprise one or a combination of:
rubber products;
food and organic waste; and,
plastic waste.

Preferably, for lignite, a typical analysis is as follows:

Compositional Analysis

| | PROXIMATE ANALYSIS | | | | | | | | | | |
|---|---|---|---|---|---|---|---|---|---|---|---|
| | (% db) | | | | | | | | | | |
| | | Volatile | Fixed | ULTIMATE ANALYSIS (% db) | | | | | Calorific Value (MJ/kg) | | |
| M % ar | Ash | Matter | Carbon | C | H | N | S | O | Gross Dry | Gross Wet | Net Wet |
| 51.40 | 5.40 | 51.00 | 43.70 | 67.30 | 5.00 | 0.65 | 1.95 | 19.80 | 26.60 | 12.90 | 11.30 |

Preferably, the mixture further comprises about 2% by weight of a binder. The binder, in turn, may comprises one or a combination of:
cement;
flour;
sodium silicate;
corn powder.

The binder may be formed from an aqueous solution of sodium silicate comprising:
Na2SiO4 mixed in a typical ratio of about 100 g to 1 litre of water at about 60° C.

The by-products of the step of reacting comprises hydrogen (H2) and at least one or a combination of:
carbon monoxide (CO);
carbon dioxide (CO2)
methane (CH4);
ethane (C2H6); and,
carburizing coke.

The method may further comprise the steps of:
extracting the by-products of the step of reacting said mixture as syngas and a solids by-product, respectively;
cooling the syngas;
separating hydrogen from the syngas.

The step of separating hydrogen from the syngas may comprise one or a combination of:
a liquification technique; and,
a membrane and filtering technique;
a vapour and gas phase recovery technique;
enrichment & separation techniques including chemicals to catalyze reactions.

The step of combining may comprise;
mixing the combination comprising the solid carbonaceous material, catalyst and binder until the combination has a thick paste-like consistency;
extruding the combination with paste-like consistency into pellets, and/or,
moulding the combination with paste-like consistency in to moulded shapes for optimizing heat transfer.

In general, the present invention also provides apparatus for producing hydrogen comprising:
a reactor having a furnace and a reaction chamber adapted for reacting an anhydrous mixture of solid carbonaceous material and a catalyst comprising alpha phase iron based material adapted to produce an exothermic reaction with the solid carbonaceous material by heating the mixture to a temperature of at least about 100° C. and up to about 1,000° C. to produce a syngas and solids by-product;
a cooling system for cooling the syngas;
a collection system for separating hydrogen from the syngas and collecting the separated hydrogen.

In the apparatus disclosed herein, the catalyst preferably comprises alpha ferrite. Further, the catalyst may comprise one or a combination of:
a ferromagnetic oxide of iron;
a ferrite;
magnetite.

As with the method disclosed herein, in use of the apparatus as disclosed, the magnetite may comprise Fe₃O₄ and the ferrite may comprise FeO. Similarly, in use of the apparatus the mixture may comprise about 90% by weight solid carbonaceous material and; about 10% by weight catalyst.

The apparatus may comprise a conveyor for processing the solids by-product wherein the conveyor includes a magnetized roller for separating magnetic particles from non-magnetic particles for one or a combination of:
use as industrial components, and;
their re-use as catalyst.

The apparatus may further comprise a control system in operative connection with one or more of the reactor, the cooling system and the collection system wherein the control system includes:
a furnace burner or heating element controller operatively connected to at least one temperature sensor located within the reaction chamber for controlling a reaction temperature of the anhydrous mixture of carbonaceous material and the catalyst;
at least one temperature sensor located between the cooling system and the collection system for measuring the temperature of the syngas at a point of collection;
at least one pressure gauge located within the collection system; and,
a display for displaying operational parameters of the apparatus based on the measurements of one or a combination of the temperature sensors and the pressure gauge.

In general, the present invention also provides an adaptation of a coal-fired electric power station where the coal-fired electric power station comprises an input coal fuel processing apparatus, an electric generator adapted for a first connection to a turbine to drive the electric generator and a second connection to an electricity distribution grid for distributing electricity generated by the electric generator, characterised in that:
the adaptation comprises the apparatus of any one of claim 23, 27 or 28 in a first operative connection with the input coal fuel processing apparatus as a supply of the carbonaceous material and a second operative connection with the turbine for supplying the separated hydrogen.

Embodiments of the present invention include control apparatus adapted to control the production of hydrogen, said apparatus including:
processor means adapted to operate in accordance with a predetermined instruction set, said apparatus, in conjunction with said instruction set, being adapted to perform and control the method steps as disclosed herein.

The control apparatus is preferably adapted to control one or a combination of the following:
temperature of at least one of:
the reacting mixture and;
the furnace;
the flow of gas products of the step of reacting;
analysis of gas products of the step of reacting;
pressure, and;
mechanical speeds of plant equipment utilised to perform the method steps as disclosed herein.

Embodiments may also include a computer program product including:
a computer usable medium having computer readable program code and computer readable system code embodied on said medium for controlling the production of hydrogen within a data processing system, said computer program product including:
computer readable code within said computer usable medium for performing the method steps as disclosed herein.

The computer program product may be adapted to control one or a combination of the following:
temperature of at least one of:
the reacting mixture and;
the furnace;
the flow of gas products of the step of reacting;
analysis of gas products of the step of reacting;
pressure, and;
mechanical speeds of plant equipment utilised to perform the method steps as disclosed herein.

Further embodiments may provide a method of producing hydrogen comprising the steps of:
combining a mixture of carbonaceous material and a catalyst comprising one or a combination of a ferrimagnetic oxide of iron and a ferrite;
reacting the mixture by heating said mixture to a temperature of at least about 100° C.

Preferably, the step of reacting the mixture includes heating said mixture to a temperature of no more than between about 110° C. to about 1,000° C.

In preferred embodiments, the catalyst includes one or a combination of magnetite and alpha ferrite. The magnetite may comprise Fe₃O₄ and the alpha ferrite may comprise FeO.

Preferably, the mixture comprises about 90% by weight carbonaceous material and; about 10% by weight catalyst.

In preferred embodiments, the method may further comprise the step of reacting a mixture of the carbonaceous material and magnetite to produce a supply of the alpha ferrite.

The step of reacting said mixture may be performed within a furnace in a reaction chamber or a retort. The furnace may be operated to a temperature of up to about 1,000° C. The reaction of the mixture becomes an exothermic reaction.

Further embodiments of the invention comprise the step of drying the mixture before the step of reacting said mixture to produce an anhydrous combination comprising the carbonaceous material and catalyst. The step of drying may be carried out at about 35° C. Before the step of drying, the mixture is prepared or moulded into shapes to facilitate optimal heat transfer. Preferably, the mixture is extruded before the step of drying to form the mixture into pellets. Alternatively, the mixture may be shredded and prepared for moulding into other shapes.

According to embodiments of the invention, the carbonaceous material comprises one or a combination of:
a coal;
sugar and/or sugar-cane;
com;
plastic, for example, polyvinyl chloride (PVC), poly ethylene terephthalate (PET), low density polyethylene (LDPE) and high density polyethylene (HDPE);
rubber;
waste pit sludge; and,
waste materials.

The waste materials may include food waste.

In preferred embodiments, the coal comprises one or a combination of Peat, Lignite; and, Sub-bituminous coal.

Preferably, the waste materials comprise one or a combination of:
rubber products;
food and organic waste; and,
plastic waste.

In a preferred embodiment, for lignite, a typical analysis is as follows:

Compositional Analysis

| | PROXIMATE ANALYSIS | | | | | | | | | | |
|---|---|---|---|---|---|---|---|---|---|---|---|
| | (% db) | | | | | | | | | | |
| | | Volatile | Fixed | ULTIMATE ANALYSIS (% db) | | | | | Calorific Value (MJ/kg) | | |
| M % ar | Ash | Matter | Carbon | C | H | N | S | O | Gross Dry | Gross Wet | Net Wet |
| 51.40 | 5.40 | 51.00 | 43.70 | 67.30 | 5.00 | 0.65 | 1.95 | 19.80 | 26.60 | 12.90 | 11.30 |

In preferred embodiments of the invention, the mixture further comprises about 2% by weight of a binder. The binder may comprise one or a combination of:
cement;
flour;
sodium silicate;
com powder.

The binder is preferably formed from an aqueous solution of sodium silicate comprising Na₂SiO₄ mixed in a typical ratio of about 100 g to 1 litre of water at about 60° C.

The products of the step of reacting said mixture may comprise hydrogen (H₂) and at least one or a combination of:
water;
carbon monoxide (CO);
carbon dioxide (CO₂)
methane (CH₄);
ethane (C₂H₆); and,
carburizing coke.

In a preferred embodiment, the methane produced in the course of the process may further react with the catalyst which breaks down the CH₄ molecule to produce hydrogen in addition to the primary reaction.

In preferred embodiments, the method may further comprise the steps of:
extracting the products of the step of reacting said mixture as syngas and a solids by-product;
cooling the syngas;
separating hydrogen from the syngas.

The step of separating hydrogen from the syngas may comprise one or a combination of:
a liquification technique; and,
a membrane and filtering technique;
a vapour and gas phase recovery technique;
enrichment & separation techniques including chemicals to catalyze reactions. Preferably, the step of combining comprises;
mixing the combination comprising the carbonaceous material, catalyst and binder until the combination has a thick paste-like consistency;
extruding the combination with paste-like consistency into pellets.

Embodiments of the present invention also provide apparatus for producing hydrogen comprising:
a reactor having a furnace and a reaction chamber adapted for reacting an anhydrous mixture of carbonaceous material and a catalyst comprising one or a combination of a ferrimagnetic oxide of iron and a ferrite by heating the mixture to a temperature of at least about 100° C. and no more than about 1,000° C. to produce a syngas and solids by-product;
a cooling system for cooling the syngas;
a collection system for separating hydrogen from the syngas and collecting the separated hydrogen.

The apparatus as disclosed is adapted to perform the method of embodiments of the invention as described herein.

Preferably the apparatus comprises a conveyor for processing the solids by-product wherein the conveyor includes a magnetized roller for separating magnetic particles from non-magnetic particles for one or a combination of:
use as industrial components, and;
their re-use as catalyst.

The apparatus may further comprise a control system in operative connection with one or more of the reactor, the cooling system and the collection system wherein the control system includes:
a furnace burner controller operatively connected to at least one temperature sensor located within the reaction chamber for controlling a reaction temperature of the anhydrous mixture of carbonaceous material and the catalyst;
at least one temperature sensor located between the cooling system and the collection system for measuring the temperature of the syngas at a point of collection;
at least one pressure gauge located within the collection system; and,
a display for displaying operational parameters of the apparatus based on the measurements of one or a combination of the temperature sensors and the pressure gauge.

Embodiments of the present invention may also provide an adaptation of a coal-fired electric power station where the coal-fired electric power station comprises an input coal fuel processing apparatus, an electric generator adapted for a first connection to a turbine to drive the electric generator and a second connection to an electricity distribution grid for distributing electricity generated by the electric generator, characterised in that:
the adaptation comprises the apparatus of embodiments disclosed herein in a first operative connection with the input coal fuel processing apparatus as a supply of the carbonaceous material and a second operative connection with the turbine for supplying the separated hydrogen.

Embodiments of the present invention provide a control apparatus adapted to control the production of hydrogen, said control apparatus including:
processor means adapted to operate in accordance with a predetermined instruction set, said apparatus, in conjunction with said instruction set, being adapted to perform and control the method steps as disclosed herein.

Preferably, the control apparatus is adapted to control one or a combination of the following:
temperature of at least one of:
the reacting mixture and;
the furnace;
the flow of gas products of the step of reacting;
analysis of gas products of the step of reacting;
pressure, and;
mechanical speeds of plant equipment utilised to perform the method steps of any one of claims 1 to 22.

Preferred embodiments also provide a computer program product including:
a computer usable medium having computer readable program code and computer readable system code embodied on said medium for controlling the production of hydrogen within a data processing system, said computer program product including:
computer readable code within said computer usable medium for performing the method steps as disclosed herein. Preferably, the computer program product is adapted to control one or a combination of the following:
temperature of at least one of:
the reacting mixture and;
the furnace;
the flow of gas products of the step of reacting;
analysis of gas products of the step of reacting;
pressure, and;
mechanical speeds of plant equipment utilised to perform the method steps as disclosed herein.

In essence, embodiments of the present invention stem from the realization that an abundant supply of H₂ was observed evolving at low temperatures by selecting an alpha phase iron-based catalyst that promotes an exothermic reaction with carbonaceous materials. In the course of conducting reduction experiments for mining applications on different ore types, the inventor utilised a mixture of a range of coal types and a catalyst comprising a combination of one or more of at least a ferromagnetic oxide of iron and a ferrite, namely, alpha ferrite. This led the inventor to trial variations or different ratios of alpha ferrite and Fe₃O₄ in combination as a ferrite and/or magnetite-based catalyst at various temperatures to successfully produce a supply of H₂ from a number of carbonaceous materials.

Other aspects and preferred forms are disclosed in the specification and/or defined in the appended claims, forming a part of the description of the invention.

Advantages provided by embodiments of the present invention comprise the following:
Low operational expenditure (OPEX) and low capital expenditure (CAPEX) may be achieved due to the low complexity of equipment and chemical processes involved.
Higher yield (kWhH₂/kg coal) than other coal-based processes.
Reduced power consumption per kilogram of Hz.
The process involves very low CO₂ emissions, which emissions can be harvested in the separation of gases at the end of the process.
Current coke manufacturing systems emit high levels of CO₂, whereas preferred embodiments emit low emissions of CO₂.
By-product of ultra-pure water for advanced industries like semiconductor manufacturing.
Solids by-products may be used for improved industrial applications, for example, improved constituents for catalytic converters.
Preferred embodiments involve a process that becomes exothermic reducing its own processing energy.
Production rate can be upscaled to production volumes to match any known steam reforming and wind or solar system.
Unlike other ‘green’ technologies that involve energy production components that may have appreciable make-up of rare-earth metals, there are minimal amounts of rare-earth metals to make up the components that are implemented for embodiments of the present invention.
Comparatively low amounts of energy are required for the production of hydrogen, for example, in the order of 5 kW per kilogram of Hz as compared to about 65 kW per kilogram of H₂ required for ‘green, brown & blue hydrogen’ production.
No CO₂ is released to the atmosphere as compared to significant amounts released indirectly to the atmosphere in known ‘brown and blue hydrogen’ production techniques.
By-products of pure-water, CO₂ and clean-Coke are produced whereas there are little or no useful by-products in known ‘green hydrogen’ production techniques.
No new power distribution infrastructure required.
Production plants in accordance with preferred embodiments can run 24/7.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 is a process workflow chart illustrating a preferred embodiment of the present invention;

FIG. 2 is a schematic diagram of apparatus utilised in performing a preferred embodiment of the present invention;

FIG. 3 is a schematic diagram of the apparatus of FIG. 2 which includes control and monitoring equipment in accordance with a preferred embodiment of the present invention;

FIG. 4 is a schematic illustration of equipment utilised to recover catalyst and solid by-product materials in accordance with a preferred embodiment of the present invention;

FIG. 5 is a schematic illustration of heat exchange equipment utilised to recover syngas products in accordance with a preferred embodiment of the present invention;

FIG. 6A is an illustration of existing electricity infrastructure in accordance with the prior art;

FIG. 6B is an illustration of an adaptation of existing electricity infrastructure in accordance with a preferred embodiment of the present invention.

### DETAILED DESCRIPTION

Embodiments of the present invention exploit the release of hydrogen from hydrocarbon compounds involving a chemical reaction enhanced by a catalyst at comparatively low temperatures in the order of about 110° C. The catalytic reaction produces solids including pure carbon and synthesis gases, which may be disassociated into, inter alia, hydrogen. As such, minor amounts of other gases are easily collected, such as methane CH₄, carbon monoxide CO, carbon dioxide CO₂ and ethane C₂H₄. As would be appreciated by the person skilled in the art, this separation of gases can be performed efficiently by one or a combination of: a liquification technique; a membrane and filtering technique; a vapour and gas phase recovery technique; and enrichment & separation techniques including additive elements such as for example, platinum, palladium, cobalt and nickel to catalyse reactions. The by-products of the process comprise ultra-pure water for some carbonaceous materials and coke. In the context of this description, the term “ultra-pure water” is used with reference to a preferred embodiment utilising lignite as the feedstock carbonaceous material and refers to the water that is removed from the ancient lignite when drying and preparing for the catalytic process. The Ultra-pure water removed from the lignite has the highest levels of purity for all contaminant types, including organic and inorganic compounds; dissolved and particulate matter; volatile and non-volatile; reactive, and inert; hydrophilic and hydrophobic; and dissolved gases.

In one aspect, preferred embodiments of the invention involve a thermo-chemical catalytic reaction of lignite as a preferred coal-derived carbonaceous material reactant for the production of hydrogen. In another aspect, preferred embodiments of the invention involve an helio-chemical catalytic reaction of plastics, rubber, freshly grown food stock like com and sugar cane, and/or other organic waste as a preferred waste-derived carbonaceous material reactant for the production of hydrogen.

In preferred embodiments, a method of producing hydrogen gas is provided using coal, in particular lignite, where the method makes use of the chemical reactivity of the lignite. By using certain catalytic compounds at low temperatures, the release of hydrogen gas is facilitated. The process is preferably carried out at low temperatures using the chemical process which in turn uses an alpha phase iron-based catalyst, where the preferred catalysts may comprise one or a combination of alpha ferrite and at least a ferromagnetic oxide of iron or, a combination of a ferromagnetic oxide of iron and a ferrite to induce an exothermic reaction. This reaction produces hydrogen in large quantities. An increase of applied heat intensifies the catalytic process. Once the temperature of the carbonaceous material and catalyst is raised beyond about 110° C., the evolution of H₂ may reach optimum levels of production as heat increases, depending on the feedstock materials being used.

By way of comparison with known techniques for hydrogen production, preferred embodiments of the present invention make use of carbon-based precursors, catalysts other organic raw materials and recycled sources which are heated to start a reaction at temperatures in the range of about 110° C. to about 115° C. and then as the temperature of reacting material rises the process becomes exothermic generating H₂ continuously without the need for further energy input. This is in contrast to known methods of hydrogen production including Green, Grey/Brown and Blues methods of hydrogen production. Furthermore, in the above-described process of preferred embodiments, CO₂ is produced at levels of between about 1% to about 10% and is able to be captured (e.g., bottled) for use as an industrial product.

A preferred embodiment involves the reaction of lignite or other carbonaceous material with a catalyst in the production of hydrogen fuel gas where the catalyst comprises a combination of one or more of magnetite as a source of Fe₃O₄ and a ferrite comprising FeO, or preferably alpha ferrite.

Resultant by-products of the reaction in preferred embodiments of the invention include a residual of materials including carburised coke ‘coke’ in various densities and weights dependent on the feedstock carbonaceous materials used. In the context of the present description, the residue of materials is a coke material which is pure carbon and includes the remnants of the catalyst materials and some ash. This residual coke material can be used for carburising in a green steelmaking process, filtration media, motor vehicle catalytic converters and the like. For example, the alpha ferrite component of this residual coke material can be isolated and used to replace platinum in catalytic converters. In this context, an improved catalytic converter utilising the alpha ferrite materials of the residual coke material will begin to react at a starting temperature of about 110° C. rather than the current 300° C. in the current incarnation of conventional catalytic converters. In preferred embodiments of the invention, the alpha ferrite coke produced as a by-product is a much cheaper and viable alternative to the way motor vehicle catalytic converters are currently made and produced. Another component of the by-product residue is pure carbon, which can be used in steelmaking and filtration media as a cheaper alternative to present manufacturing processes. Furthermore, the manufacture of these carbon-based materials is performed without the CO₂ emissions of current methods of their manufacture. Typical NATA laboratory spectrometer analysis results on residue solids are inserted below in Table 1.

TABLE 1
SPECTROMETER SERVICES PTY. LTD.
SPECTROGRAPHIC AND CHEMICAL ANALYSIS

[symbol]

[symbol]

| | | | |
|---|---|---|---|
| BXB TECHNOLOGIES | [symbol] | Report Number: | [symbol] |
| [symbol] | [symbol] | Report Date: | Thursday, 28 Oct. [symbol] 2021 |
| [symbol] | [symbol] | Job Number: | [symbol] |
| [symbol] | | [symbol] | |

| | Certificate Of Analysis | | | | | | | | | | | | | | | | |
|---|---|---|---|---|---|---|---|---|---|---|---|---|---|---|---|---|---|
| | SiO₂ | Al [symbol] O₃ | Fe [symbol] O [symbol] | CaO | MgO | Na₂O | K₂O | MnO | TiO₂ | [symbol] | ZnO | CaO | Cr [symbol] O [symbol] | M [symbol] O [symbol] | [symbol] | C | S |
| Samples | % | % | % | % | % | % | % | % | % | % | % | % | % | % | % | % | % |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | 1.63 |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | 1.12 |
| [symbol] | 10.3 | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| Methods | Notes: | | | | | | | | | | | | | | | | |
| Used | [symbol] | | | | | | | | | | | | | | | | |
| [symbol] | | | | | | | | | | | | | | | | | |
| [symbol] | | | | | | | | | | | | | | | | | |

[symbol]

indicates data missing or illegible when filed

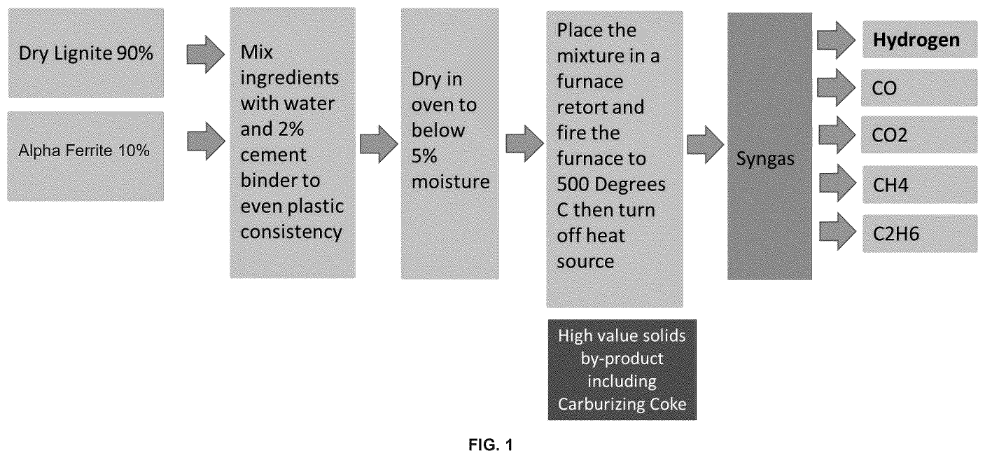

With reference to FIG. 1, which shows one embodiment of the invention, raw input material in an exemplary composition of typically about 90% lignite together with an alpha phase iron-based catalyst of alpha ferrite making up typically about 10% of the ingredients are mixed with water and a binder. Other embodiments may involve an alpha phase iron-based catalyst that comprises a combination of magnetite and ferrite, namely, alpha ferrite. A preferred binder for this reaction is a compound of sodium silicate mixed with water in a composition that makes up about 2% of the total weight of the produced batch. Several compositions for binders have been trialed with compositions comprising, cement, flour, sodium silicates and corn powder. In another embodiment utilising organic wastes instead of lignite as a reactant source of hydrogen, the preferred binder comprises a solution of hot water at about 60° C. and a Sodium Silicate Na₂SiO₄ mix, in a ratio of 100 grams of Na2SiO4 to 1 litre of water. This water is used for adding to the mixing process, but not always used totally, only until the mix is homogeneous and firm giving an appropriate consistency for preparing the reactants.

The lignite and catalyst components are weighed to achieve the respective percentages of the net weight of each process batch. This mixture is combined to form a homogeneous consistency using a paddle mixer or the like, by way of example, producing a consistency of about 60% moisture content for 1 hour per 5-ton load. Essentially, the mixture will form a “dry-mix” such that, the mixture is ready when it can be formed into a homogeneous clay-like material that can be extruded through dies. At that consistency, the mixture is ready for further processing.

To assist in the efficient processing of the following steps, the combined mixture is then extruded in an extruder to produce a pelletized material ready for drying and thermal processing. When the mixture is homogeneous and has the right moisture content, the product is extruded to provide pellets of the desired size. By way of example, the mixture may be processed in an extruder at a rate of 1 ton/hour through a die that produces 8 mm pellets. For example, in a laboratory-scale plant, 25 mm round pellets are produced. The combined mixture is then dried in an air recirculating drying cabinet or equivalent oven to an extent that it contains less than about 5% moisture. In an example of drying, the palletized mixture is placed on a tray(s) with recirculating air at about 35° C. until it contains less than about 5% moisture. Preferably, the tray(s) are placed on shelves and designed to allow free-flowing warm air (about 35° C.) to pass across the surface of the, or each tray. Prior to heating, the dried mixture may be weighed again.

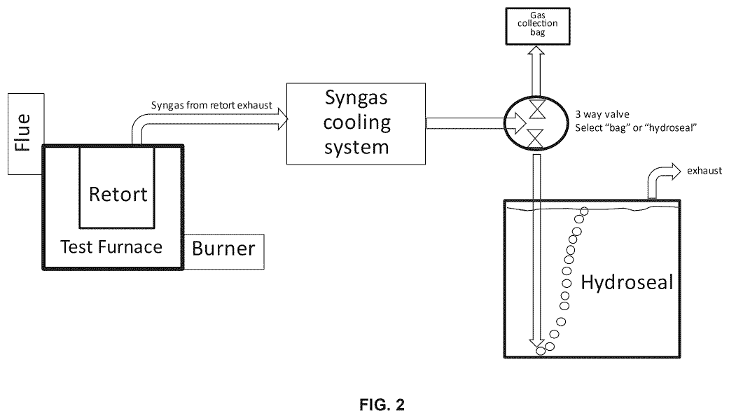

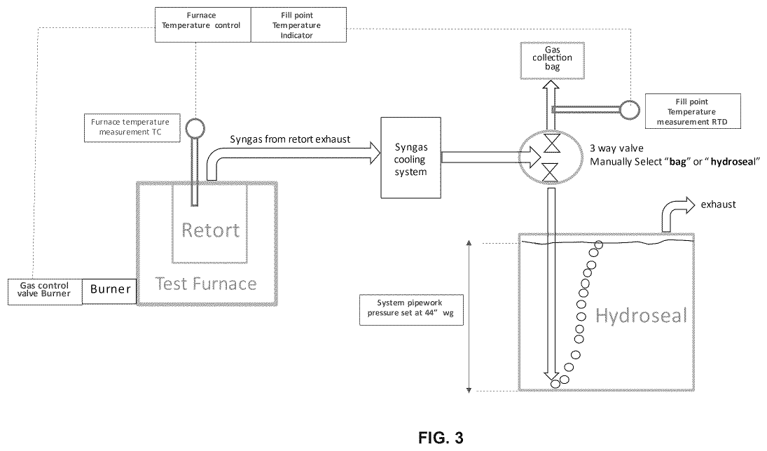

With reference to both FIG. 1 and FIG. 2, the dried combined mixture is then thermally processed and may be placed in a furnace retort where the furnace is fired to a setpoint [“*Pini Comment: for this setpoint!*”] to control the temperature for evolving the H₂ efficiently. In this respect, the hydrogen-producing reaction will commence at a temperature of reactants of around 100° C. In the heating process, the retort is placed in the furnace and then the dried pellets are placed in the retort. A lid seal is then placed on a retort flange. The lid of the retort is then closed and bolted down firmly for a gas-tight finish. A syngas outlet pipe is then connected to a cooling inlet and finally, one or more thermocouples are connected to the retort lid. Control and monitoring of the process is shown in more detail in FIG. 3. FIG. 2 illustrates a suitable furnace as shown. The furnace may be a steel structure insulated with a suitable form of refractory insulation. An exemplary insulation may be alumina-based ceramic fiber. A suitable form of such insulation is commercially available as Fibrefrax™ insulation.

The raw materials are placed in the retort. The gas-tight sealed retort is placed into the furnace. A gas burner then fires flame into the bottom of the furnace chamber.

The process works to break down the chemical composition of hydrocarbons to release the hydrogen and deposit carbon.

As may be appreciated by the person skilled in the art, relative volumes of the resultant gases are subject to optimization in pressure, residence time and temperature of the system. The system is to be optimized to produce the most H₂ and the minimum CO₂ and CO.

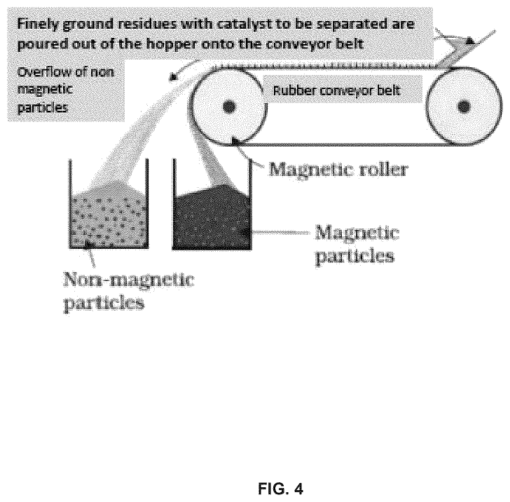

In a preferred embodiment, the catalyst comprises magnetite substantially consisting of Fe₃O₄ and this may also be recoverable after the thermal process is complete. FIG. 4 shows an exemplary configuration of a conveyor that can be used to recover the catalyst utilising the properties of its constituent ferrimagnetic oxides of iron, where a preferred embodiment involves a magnetite catalyst. The magnetic particles are separated in and by the conveyor. FIG. 4 shows an exemplary configuration of a conveyor that can be used to recover the catalyst derived from the reaction. As shown, a magnetic roller is utilised to separate magnetic particles from non-magnetic particles for their re-use. The recovered iron mix is comprised of the ferrite-based catalyst.

In general, products of the heated chemical reaction that takes place are as follows:
High-value solids as a by-product including;
   carburising coke-pure carbon.
synthesized gaseous products, namely, Syngas or fuel gas mixture comprising;
   carbon monoxide CO;
   carbon dioxide CO₂;
   methane CH₄;
   ethane C₂H₆, and;
   hydrogen H₂.

The ratios of the various products may change with differing input reactants and conditions. Carbon monoxide, CO, typically up to 10% of the products, and may be bottled and sold to industry. Carbon dioxide CO₂; typically, about 15%-24%, and also may be bottled and sold to industry. Methane CH₄; typically, up to about 40%, and is produced pure to industrial standards and may be harvested and sold to industry. Ethane C₂H₆; typically, up to about 8%, is also pure to industrial standards and may be harvested and sold to industry. Carburising coke. typically, up to about 45% of the original mass, is also pure to industrial standards and may also be harvested and sold commercially.

The solids by-product may have a number of industrial uses by virtue of its composition from the catalytic reaction. For example, this ferrite material component may be a useful replacement for platinum in catalytic converters in automobiles. Advantageously, the solid by-product used in a catalytic converter will start reacting at 110° C. to break down hydrocarbons in exhaust gases, compared to platinum, which starts to react at 300° C., allowing hydrocarbons to exhaust into the atmosphere until the engine of a vehicle warms up. The solids by-product can also be used as a carburiser in foundry and steelmaking operations, replacing existing carburisers. One of the benefits being that the by-product can be loaded safely into the furnace charge with electro-magnets. It can be used as a filtration compound in the water treatment and chemical manufacturing industry. It is also envisaged that the solids by-product may be useful as a source material for the manufacture of graphene.

With reference to FIG. 2 or 3, a gas burner or heat source of any known configuration, as would be appreciated by the person skilled in the art may be utilised in the H₂ production process, according to preferred embodiments. By way of example, a heat source utilising induction or electric elements could be suitable as alternatives to gas burners. The retort with reactant materials is then placed into the furnace. The lid of the furnace is bolted to a retort flange and sealed with a gasket. As set up, the burner combustion exhaust gases will exit at a flue as shown in FIG. 2. Operationally, the following steps are performed in accordance with a preferred embodiment.

On ignition of the gas burner, its flames transfer the heat produced to the outer skin of the retort heating the contents inside the retort. A furnace controller regulates the gas input to maintain the set temperature of the contents.

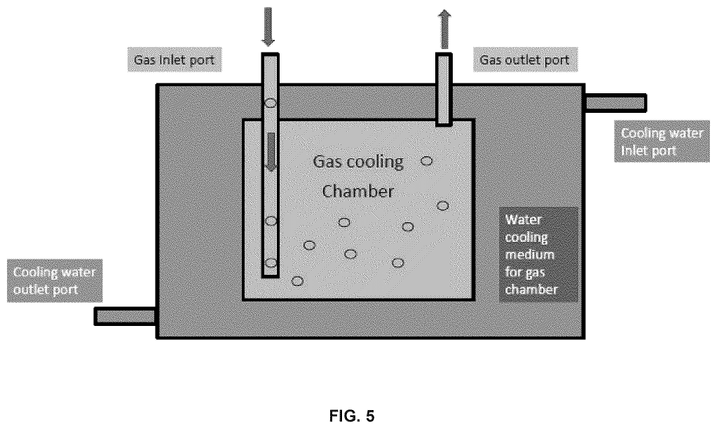

A thermocouple measures the temperature of the contents inside the retort as shown in FIG. 3. The thermocouple is in approximately the top centre of the seal plate, placed 100 mm above the base of the retort. As the heat increases, the evolved gases are expelled from the retort and piped to a cooling system as shown in FIG. 2. An exemplary cooling system is shown in FIG. 5 in which syngas enters the cooling system at a gas inlet port and passes through a gas cooling chamber. Whilst in transit through the gas cooling chamber the syngas is cooled by cooling water passing through an outer cooling medium chamber where the cooling water enters the outer cooling medium chamber at a cooling water inlet port and exits the outer cooling medium chamber via a cooling water outlet port.

After being cooled the gases are passed through a hydroseal. The hydroseal acts as a backflow seal and a scrubber. A sampling of the gases produced may be carried out using aluminium foil gas collection bags, as would be appreciated by the person skilled in the art. Sampling has taken place during experimentation as per the following design sheet.

During trial production, the gases have been collected as needed for analysis at a NATA accredited laboratory.

### Experimental Results

The following is a typical report from a NATA accredited laboratory that provided testing in experimentation to show the veracity of the present invention.

Analysis of samples J/N 21920 Test 1 and J/N 21920 Test 2, sampled on 20/09/2021, was undertaken on 20/09/21⁷. ⁷Method Reference: WI-UC-086: All results reported on a dry gas and sulfur-free basis. Expanded uncertainties are estimated to be ±3% (relative) for values above 1 mol % and ±10% (relative) or ±0.002 mol % (whichever is larger) below 1 mol % and were estimated using a coverage factor of 2 and define an interval estimated to have a level of confidence of 95%. Samples analysed: 20/09/2021 Lab request number: 211215 HRL Sample ID: J/N 21920 BXB Test 1 211215-1, J/N 21920 BXB Test 2 211215-2
Concentration (mol %) Composition J/N 21920
Test 1
Hydrogen 37.02
Methane 7.71
Ethane 0.14 C6+ 0.248
Carbon Dioxide 18.67
Oxygen plus Argon* 1.43
Nitrogen 26.92

As a precursor step, ferrite-based catalysts may be produced by reacting a magnetite source of Fe₃O₄ with a coal form of carbonaceous material, namely lignite. This reaction produces the conditions for producing alpha iron ferrite as illustrated in the iron-carbon phase diagram of Diagram 1, below.

Another preferred embodiment of the invention involves substituting lignite with the raw input of waste materials comprising one or a combination of food matter, tyres or plastic processing. By way of example, it is envisaged that this embodiment may also provide for extracting H₂ from plastic and tyres. In this embodiment, hydrogen may be produced from food matter, tyres and plastic waste using a similar chemical reaction. This hydrogen production process also involves the input materials of one or a combination of waste food matter, tyres and plastic combined with a magnetite catalyst with an appropriate and different binder, which is better for the binding of the catalyst to food, tyres and plastic instead of coal. In this respect, as noted above, utilising organic wastes instead of lignite as a reactant source of hydrogen, the preferred binder comprises a solution of hot water at about 60° C. and a Sodium Silicate Na₂SiO₄ mix, in a ratio of 100 grams of Na₂SiO₄ to 1 litre of water. This water is used for adding to the mixing process, but not always used totally, only until the mix is homogeneous and firm giving an appropriate consistency for preparing the reactants.

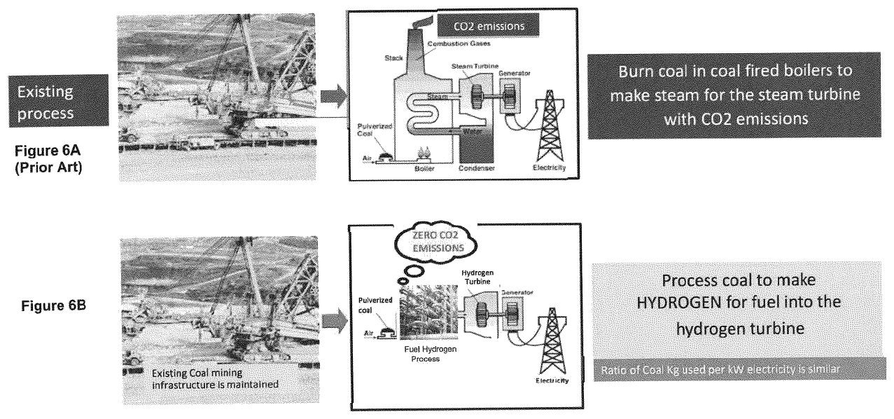

It will also be appreciated that embodiments of the invention may be dovetailed straight into an existing coal-fired electric power station creating zero CO₂ in comparison to existing green energy solutions. With reference to FIG. 6A and FIG. 6B, an envisaged adaptation of a coal-fired electric power station and its infrastructure may take the form of the coal-fired electric power station comprising an input coal fuel processing apparatus, a steam generating boiler adapted for a first connection to a steam turbine to drive the electric generator and a second connection to an electricity distribution grid for distributing electricity generated by the electric generator, where the adaptation is characterised in that the adaptation comprises the apparatus of FIGS. 2 and/or 3 in a first operative connection with the input coal fuel processing apparatus as a supply of the carbonaceous material and a second operative connection with the turbine for supplying the separated hydrogen.

The adaptation of a coal-fired electric power station and its infrastructure exemplified in FIGS. 6A and 6B may comprise the apparatus described herein for like industries which require to remain operational on a 24/7 basis to help reduce the need for conventional modes of high carbon emitting fuels. An example of this includes but is not limited to industries such as galvanising plants, cement manufacturers, aluminium smelters, steel mills (glass furnaces). The process of converting carbonaceous materials to syngas or its by-products helps reduce the carbon footprint due to the hydrogen content of the syngas. The syngas can be either blended into the existing fuel supply or used exclusively with other plant and equipment as an alternative.

The adaptive technology can be extended to include the installation of a hydrogen injection system into stationary and mobile Diesel engines. With direct injection of syngas produced in accordance with embodiments of the invention to augment the diesel injection, the emitted carbon will be reduced significantly (for example, by around 25%) compared to the straight diesel emissions.

Certain embodiments of the present invention may enable existing coal mining infrastructure to be maintained as operational into the future where instead of burning coal in coal-fired boilers to make steam for a steam turbine, the boilers may be substituted for apparatus in accordance with a preferred embodiment to convert the input coal to its equivalent mass of hydrogen to be used in a hydrogen fired turbine to produce electricity. With this, existing electrical power distribution infrastructure that currently extends from traditional coal-fired power stations may also be maintained as operational into the future.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above-described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practised. In the following claims, any means-plus-function clauses are intended to cover structures as performing the defined function and not only structural equivalents but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures. Furthermore, and by way of example to specific embodiments of the present invention, variation and modification to specific ratios of component input reactant materials of the present invention are envisaged to provide for optimum production of resultant products of the inventive processes in correspondence with varying conditions such as in relation to temperature and pressure, for example.

The following sections I-VII provide a guide to interpreting the present specification.

### I. Terms

The term “product” means any machine, manufacture and/or composition of matter, unless expressly specified otherwise.

The term “process” means any industrial process, algorithm, method or the like, unless expressly specified otherwise.

The term “anhydrous” means with reference to any combination or mixture of materials disclosed herein an absence of water or moisture at least to a percentage weight of water of at least 5% or less.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has a sufficient antecedent basis.

The term “invention” and the like mean “the one or more inventions disclosed in this specification” unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention unless expressly specified otherwise.

A reference to “another embodiment” in describing an embodiment does not imply that the referenced embodiment is mutually exclusive with another embodiment (e.g., an embodiment described before the referenced embodiment) unless expressly specified otherwise.

The terms “including”, “comprising” and variations thereof mean “including but not limited to” unless expressly specified otherwise.

The terms “a”, “an” and “the” mean “one or more” unless expressly specified otherwise.

The term “plurality” means “two or more” unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things unless expressly specified otherwise. For example, the phrase “at least one of a widget, a car and a wheel” means either (I) a widget, (il) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate the quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title nor the Abstract in this specification is intended to be taken as limiting in any way as the scope of the disclosed invention(s). The title and headings of sections provided in the specification are for convenience only and are not to be taken as limiting the disclosure in any way.

Numerous embodiments are described in the present application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) that must be present in all embodiments.

Devices that are described as in communication with each other need not be in continuous communication with each other, unless expressly specified otherwise. On the contrary, such devices need only transmit to each other as necessary or desirable, and may actually refrain from exchanging data or material most of the time. For example, a machine in communication with another machine via the Internet may not transmit data to the other machine for long period of time (e.g., weeks at a time). In addition, devices that are in communication with each other may communicate directly or indirectly through one or more intermediaries. The same may apply for industrial machinery and equipment.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive unless expressly specified otherwise. Likewise, an enumerated list of items (which may or may not be numbered) does not imply that any or all of the items are comprehensive of any category unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative and do not imply that the invention or any embodiments were made or performed, as the case may be.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

We claim:

1. A method of producing hydrogen comprising the step of:
reacting a combination of solid carbonaceous material and a catalyst comprising alpha phase iron-based material adapted to produce an exothermic reaction with the solid carbonaceous material.

2. The method of claim 1, comprising the steps of:
combining a mixture of the solid carbonaceous material and the catalyst;
reacting the mixture by heating said mixture to a temperature of at least about 110° C., and wherein the catalyst comprises one or a combination of:
a ferrimagnetic oxide of iron;
a ferrite, wherein the ferrite comprises FeO;
magnetite, wherein the magnetite comprises Fe₃O₄;
alpha ferrite.

3.-5. (canceled)

6. The method of claim 2, wherein the mixture of the solid carbonaceous material and the catalyst comprises:
about 90% by weight solid carbonaceous material;
about 10% by weight catalyst; and
wherein the step of reacting the mixture includes heating said mixture to a temperature of up to about 1,000° C.

7. (canceled)

8. The method of claim 1, comprising the step of:
reacting the mixture of the solid carbonaceous material and the catalyst to produce a supply of alpha ferrite for further catalysing the reaction.

9. The method of claim 2, wherein the step of reacting is performed within a furnace in a reaction chamber or a retort and comprises one or a combination of the steps of:
operating the furnace to a temperature of no more than about 1,000° C. to sustain an exothermic reaction of the mixture of solid carbonaceous material and the catalyst;
drying the mixture before the step of reacting said mixture to produce an anhydrous combination comprising the carbonaceous material and the catalyst, wherein the step of drying is carried out at about 35° C.

10.-12. (canceled)

13. The method of claim 9, further comprising one or more of the steps of:
extruding the mixture before the step of drying to form the mixture into pellets
moulding the mixture before the step of drying to form the mixture into moulded shapes for optimizing heat transfer.

14. The method of claim 1, wherein the solid carbonaceous material comprises one or a combination of:
a coal, wherein the coal comprises one or a combination of peat, ignite, and sub-bituminous coal;
sugar and/or sugar-cane;
corn;
plastic, wherein the plastic comprises one or a combination of polyvinyl chloride (PVC), poly ethylene terephthalate (PET), low density polyethylene (LDPE), and high density polyethylene (HDPE);
tyres and rubber products;
waste pit sludge; and,
waste materials, wherein the waste materials comprise one or a combination of tyres and rubber products, food and organic waste, and plastic waste.

15.-17. (canceled)

18. The method of claim 14, wherein the lignite has a compositional analysis of:
Compositional Analysis

| | PROXIMATE ANALYSIS | | | | | | | | | | |
|---|---|---|---|---|---|---|---|---|---|---|---|
| | (% db) | | | | | | | | | | |
| | | Volatile | Fixed | ULTIMATE ANALYSIS (% db) | | | | | Calorific Value (MJ/kg) | | |
| M % ar | Ash | Matter | Carbon | C | H | N | S | O | Gross Dry | Gross Wet | Net Wet |
| 51.40 | 5.40 | 51.00 | 43.70 | 67.30 | 5.00 | 0.65 | 1.95 | 19.80 | 26.60 | 12.90 | 11.30. |

19. The method of claim 2, wherein the mixture further comprises about 2% by weight of a binder and wherein the binder comprises one or a combination of:
cement;
flour;
sodium silicate;
corn powder.

20. (canceled)

21. The method of claim 19, wherein the binder is formed from an aqueous solution of sodium silicate comprising Na₂SiO₄ mixed in a typical ratio of about 100 g to 1 litre of water at about 60° C.

22. The method of claim 1 wherein by-products of the step of reacting comprises hydrogen (H₂) and at least one or a combination of:
carbon monoxide (CO);
carbon dioxide (CO₂)
methane (CH₄);
ethane (C₂H₆); and,
carburizing coke; and
wherein the method further comprises the steps of:
extracting the by-products of the step of reacting said mixture as syngas and a solids by-product, respectively;
cooling the syngas;
separating hydrogen from the syngas.

23. (canceled)

24. The method of claim 22, wherein the step of separating hydrogen from the syngas comprises one or a combination of:
a liquification technique; and,
a membrane and filtering technique;
a vapour and gas phase recovery technique;
enrichment and separation techniques including chemicals to catalyze reactions.

25. The method as claimed in claim 2, wherein the step of combining comprises;
mixing the combination comprising the solid carbonaceous material, catalyst and binder until the combination has a thick paste-like consistency;
extruding the combination with paste-like consistency into pellets, and/or,
moulding the combination with paste-like consistency in to moulded shapes for optimizing heat transfer.

26. An apparatus for producing hydrogen, comprising:
a reactor having a furnace and a reaction chamber adapted for reacting an anhydrous mixture of solid carbonaceous material and a catalyst comprising alpha phase iron based material adapted to produce an exothermic reaction with the solid carbonaceous material by heating the mixture to a temperature of at least about 110° C. and up to about 1,000° C. to produce a syngas and solids by-product;
a cooling system for cooling the syngas;
a collection system for separating hydrogen from the syngas and collecting the separated hydrogen, wherein the catalyst comprises one or a combination of:
a ferrimagnetic oxide of iron;
a ferrite, wherein the ferrite comprises FeO;
magnetite, wherein the catalyst comprises Fe₃O₄;
alpha ferrite.

27.-30. (canceled)

31. The apparatus of claim 26, comprising a conveyor for processing the solids by-product wherein the conveyor includes a magnetized roller for separating magnetic particles from non-magnetic particles for one or a combination of:
use as industrial components, and;
their re-use as catalyst.

32. (canceled)

33. An adaptation of a coal-fired electric power station where the coal-fired electric power station comprises an input coal fuel processing apparatus, an electric generator adapted for a first connection to a turbine to drive the electric generator and a second connection to an electricity distribution grid for distributing electricity generated by the electric generator, characterised in that:
the adaptation comprises the apparatus of claim 26, in a first operative connection with the input coal fuel processing apparatus as a supply of the carbonaceous material and a second operative connection with the turbine for supplying the separated hydrogen.

34. A control apparatus adapted to control the production of hydrogen, said apparatus including:
processor means adapted to operate in accordance with a predetermined instruction set, said apparatus, in conjunction with said instruction set, being adapted to perform and control the method steps as claimed in claim 1.

35. The control apparatus of claim 34, wherein the control apparatus is adapted to control one or a combination of the following:
temperature of at least one of:
the reacting mixture and;
the furnace;
the flow of gas products of the step of reacting;
analysis of gas products of the step of reacting;
pressure, and;
mechanical speeds of plant equipment utilised to perform the steps of claim 1.

36.-39. (canceled)
